(19) United States
(12) Patent Application Publication
(10) Pub. No.: US 2003/0015106 A1
(43) Pub. Date: Jan. 23, 2003

(54) Sheet-fed printing press with screen-printing cylinder

(76) Inventor: Johannes Georg Schaede, Wurzburg (DE)

Correspondence Address: Douglas R Hanscom, Jones Tullar & Cooper, Eads Station, PO Box 2266, Arlington, VA, 22202, US

(21) Appl. No.: 10/181,419

(22) PCT Filed: Dec. 16, 2000
(86) PCT No.: PCT/DE00/04505

(30) Foreign Application Priority Data
Jan. 25, 2000 (DE) 100 02 972.8
May 25, 2000 (DE) 100 25 995.2

(51) Int. Cl. B41L 13/04

(52) U.S. Cl. 101/116

(57) ABSTRACT

The invention relates to a printing unit (4) with a first screen-printing cylinder (12) that, together with a second cylinder (17), defines a printing gap (14), said printing unit being characterized in that the second cylinder (17) is likewise a screen-printing cylinder.

Eine Druckeinheit (4) mit einem ersten Siebdruckzylinder (12), der zusammen mit einem zweiten Zylinder (17) einen Druckspalt (14) bildet, dadurch gekennzeichnet, dass der zweite Zylinder (17) ebenfalls ein Siebdruckzylinder ist.

The invention relates to a printing unit with a screen-printing cylinder according to the preamble to claims 1 or 4.

EP 07 23 864 B1 has disclosed a printing unit for a rotary printing press, which has a first screen-printing cylinder, which, together with a second cylinder, forms a printing, nip in which a print stock is printed.

This known printing unit is only suitable for one-sided printing.

DE 26 38 344 A1 discloses two cooperating screen-printing cylinders.

JP 63-071350 A discloses two opposing printing cylinders, each with a doctor blade. A separation between a doctor blade and a counter-pressure device is not provided.

The object of the invention is to produce a printing unit with a screen-printing cylinder.

The object is attained according to the invention by the characteristics of claims 1 or 4.

The advantages that can be achieved with the invention are comprised particularly in the fact that it permits first forme printing and second forme printing in the screen-printing process with matching registers to be executed in a single printing procedure.

To this end, the invention provides that the second cylinder is also a screen-printing cylinder so that each screen-printing cylinder is used to print a respective side of a print stock being fed through the printing nip.

In order to permit an exact, register-matching printing even at the edge of a sheet-like print stock, preferably at least one of the two screen-printing cylinders is equipped with a holding mechanism for the sheet-like print stock.

In order for this holding mechanism to be able to pass through the printing nip, it is necessary for at least one of the two screen-printing cylinders to have an indentation on its circumference surface. A doctor blade device disposed inside the screen-printing cylinder can preferably be moved radially so that it can move out of the way of the indentation.

It is also preferable for the doctor blade devices of the two screen-printing cylinders to each have a working doctor blade, which touches the screen when pressing ink through it, the working doctor blade of the two doctor blade devices being exactly aligned with each other, so that the working doctor blade of each doctor blade device compensates for a pressure exerted on its screen by the working doctor blade of the other. This arrangement provides the simple assurance that there is a sufficient pressure in the printing nip to press the ink required for the printing through the screens and to transfer it onto the print stock; on the other hand, an undesirable deformation of each screen by the pressure of the doctor blade device associated with it is prevented because the respective other doctor blade device exerts a corresponding counter-pressure.

Alternatively to this, each doctor blade device can also have a counter-pressure device spaced apart from the working doctor blade in the circumference direction, which is aligned with the respective working doctor blade of the other doctor blade device and compensates for its pressure.

In addition to their previously customary task of applying ink to the screen-printing cylinder, the doctor blade devices thus also perform the task of the counter-pressure cylinder that is usually used.

Exemplary embodiments of the invention are shown in the drawings and will be described in detail below.

FIG. 1 is a schematic representation of a printing press with a printing unit;

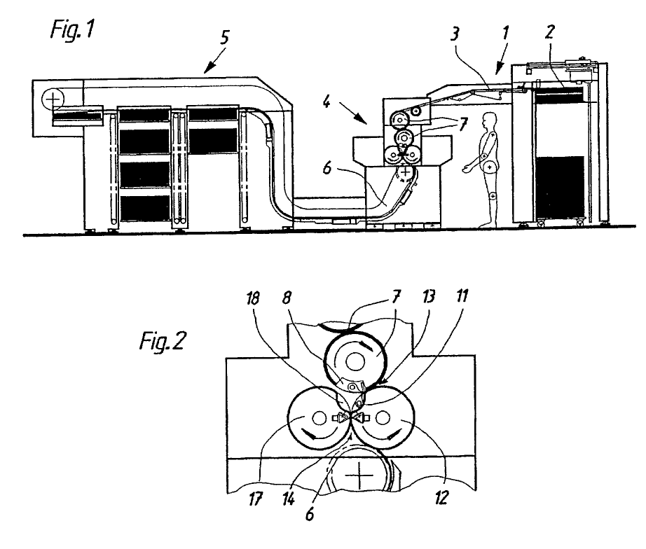

FIG. 2 shows a schematic section through the printing unit of the machine from FIG. 1;

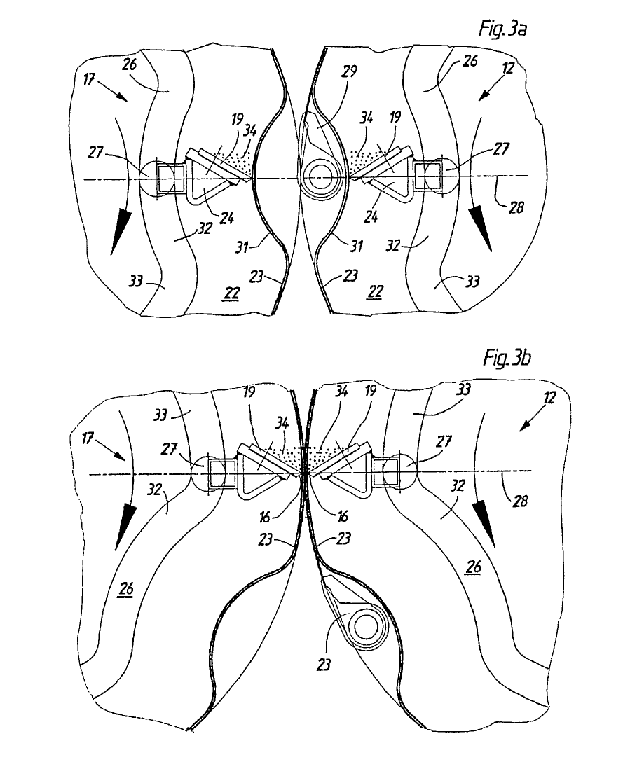

FIGS. 3a and 3b respectively show the printing nip and partial regions of the screen-printing cylinders that form the printing nip, according to a first embodiment of the printing unit, in two phases of its rotary motion;

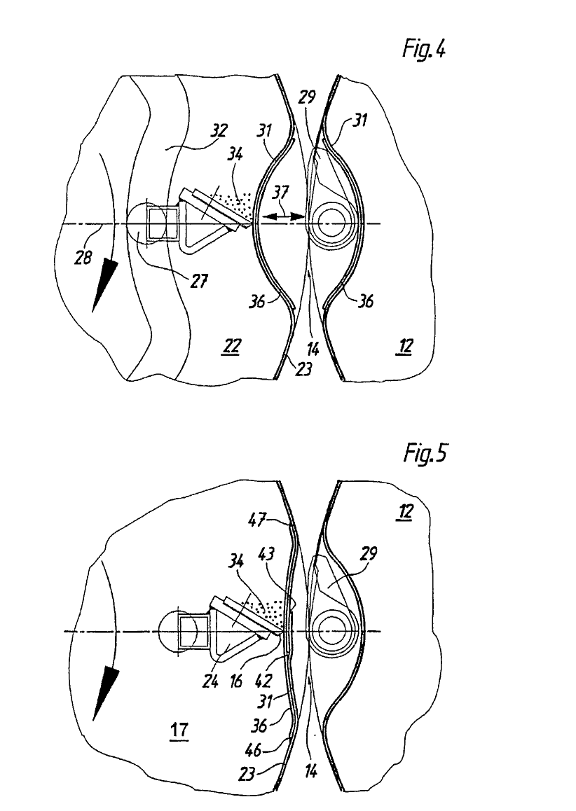

FIGS. 4 and 5 show examples of the design of the indented section of the circumference surface of the screen-printing cylinder;

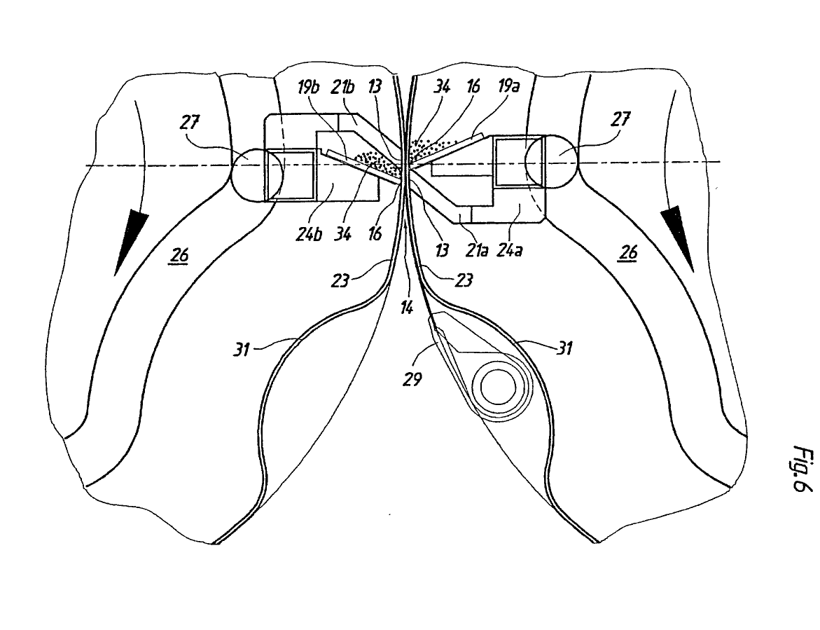

FIG. 6 shows the printing nip and partial regions of the screen-printing cylinders that form the printing nip, according to a second embodiment of the printing unit.

FIG. 1 shows a schematic view, e.g. of a sheet-fed rotary printing press in which the printing unit 4 according to the invention is used. The printing press has a sheet feeder 1 with a sheet stacker 2, from whose top, which is automatically kept at a constant height, sheets are fed individually or in a continuous stream by a belt conveyor 3 to the printing unit 4, which takes the sheets one at a time, prints them, and outputs them to a second chain conveyor 6, which in the case of multicolor printing, feeds them to other printing units like the printing unit 4 or, as shown here, feeds them directly to an output stack 5.

The sheets pass through the printing unit 4 from top to bottom; FIG. 2 gives a larger scale depiction of its design.

Two transport cylinders 7, the upper of which is shown only partially in the figure, are each provided with holding mechanisms in a respective section 8 of their circumferences in order to take the edges of sheets, which are to be printed, from the first belt conveyor 3 in a register-matching manner. The lower of the two transport cylinders 7 rolls in contact with a first screen-printing cylinder 12, which is likewise equipped with a holding mechanism 29 in a section 11 of its circumference, in particular a gripper bridge 29 (see FIG. 3a) for taking the sheets from the lower transport cylinder 7. The first screen-printing cylinder 12, together with a second screen-printing cylinder 17, forms a printing nip 14 through which the sheets held by the gripper bridge 29 of the first screen-printing cylinder 12 are conveyed. The two screen-printing cylinders 12; 17 can be rotated in unison in such a way that with each pass through the printing nip 14, the gripper bridge 29 of the first screen-printing cylinder 12 coincides with a channel-like indented section 18 of the second screen-printing cylinder 17.

The operation of the screen-printing cylinders 12; 17 and a first example of their design will be described below in conjunction with FIGS. 3a and 3b.

FIGS. 3a, 3b each show a partial region of the two screen-printing cylinders 12; 17 in the vicinity of the printing nip 14.

At each of its axial ends, each screen-printing cylinder 12; 17 has a support ring 22 whose outer circumference has a screen 23 stretched onto it, e.g. made of silk or polyamide gauze or bronze wire mesh. On the interior of the screen-printing cylinder 12; 17, a doctor blade device 24 is provided, whose position in the radial direction is controlled by a curved body, in this instance a guide slot 26 embodied at the ends of the screen-printing cylinder 12; 17, through which a cylindrical guide projection 27 of the doctor blade device 24 extends. Outside the screen-printing cylinder 12; 17, the guide projection 27 is supported at both ends so that it can move in the direction of the line 28 connecting the rotation axes of the screen-printing cylinder 12 and the screen-printing cylinder 17. FIG. 3a shows the doctor blade device 24 in a position in which the gripper bridge 29 of the screen-printing cylinder 12 is passing through the printing nip 14 between the two cylinders. In the vicinity of the gripper bridge 29 and opposite from it, the screen 23 has a section 31 that is indented radially inward. The guide slot 26 has an arc-shaped section 33, not shown completely in the Fig., which is concentric to the cylindrical outer surface of the screen 23, and an inwardly indented section 32, whose curvature corresponds to that of the section 31. The curvature of the section 32 is selected so that when the section 32 moves past the guide projection 27 during the rotation of the screen-printing cylinder 12, the doctor blade device 24 is retracted radially inward so far that it exerts only a minimal pressure against the screen 23, which produces no appreciable deformation of the screen 23 in the section 31, or is retracted so far that it loses all contact with the screen 23 and consequently exerts no pressure on its section 31, which could deform this section and damage it during the course of operation.

FIG. 3b shows the position of the doctor blade devices 24 after the section 32 has passed the guide projection 27. The arc-shaped section 33 of the guide slot 26 keeps the doctor blade devices 24 pressed against the inside of the screen 23 so that an ink 34 disposed against a working doctor blade 19 of the doctor blade device 24 is pressed through the open regions of the screen 23 and is thus applied to a sheet of print stock conveyed through the printing nip 14.

In this phase of the rotation of the two screen-printing cylinders 12; 17, the respective lips 16 of the two working doctor blades 19 touching the screens 23 are oriented toward each other and rest exactly in a plane defined by the axes of the two screen-printing cylinders 12; 17, which plane is represented by the line 28 in the figure.

The parallelism of the lips 16 is of great importance for satisfactory printing results; if the lips 16 are not parallel to each other, but rather intersect, there is the possibility that away from the intersecting point, the screen 23 will move away from the pressure exerted against its inside by the doctor blade device 24, with the result that little or no ink 34 is pushed through the screen 23, and this ink, for lack of effective pressure, is transferred either incompletely or not at all to a sheet being fed through the printing nip 14.

It is easy to see that the requirement for the lips 16 to be parallel is greater, the narrower the zone is in which the lip 16 and screen 23 contact each other. It is consequently useful to select the elasticity of the material of the working doctor blades 19 and the pressure of the doctor blade device 24 against the screen 23 to be great enough for a sufficient width of the contact zone to be produced. With an axial length of the screen-printing cylinders 12; 17 of approximately 800 to 900 mm, it is desirable for the contact zone to extend at least 0.05 to 1 mm, preferably approx. 0.3 to 0.4 mm in the circumference direction of the screen-printing cylinders 12; 17. With axial lengths that differ from this, a proportionally larger or smaller width can be selected.

According to a second embodiment shown in FIG. 4, the doctor blade device 24 of the screen-printing cylinder 17 remains in contact with the screen 23 even during its passage through the indented section 31. In this case, in order to prevent the doctor blade device 24 from deforming the screen 23 in the section 31, the screen 23 is supported on the outside by a support element 36. The support element 36 here is the shape of a basin or trough that is uniformly curved in cross section, for example made of sheet metal or a rigid plastic, and is anchored at its two axial ends to the ends of the screen-printing cylinder 17. Advantageously, the leading and trailing ends of the screen 23 are also disposed in the section 31, where they are covered by the support element 36. The support element 36 can be adjusted in the radial direction (arrow 37) in order to set the tension of the screen 23.

The screen-printing cylinder 12 has a corresponding support element 36 in its indented section 31.

Since no ink can be transferred from the screen-printing cylinders 12; 17 to the print stock in the indented sections 31 supported by the support element 36, it is useful for the support element 36 to be a closed plate which does not permit any ink 34 to pass through and reach the exterior of the screen-printing cylinder 12; 17.

FIG. 5 shows a detail of an alternative design of the screen-printing cylinder 17.

The support element 36 here is affixed radially inside the screen 23 and the leading end 42 and trailing end 43 of the screen 23 overlap each other in the section 31 supported by the support element 36. In this manner, the sensitive connection between the two ends 42; 43 of the screen 23, which can be welded to each other, for example, is protected from contact with the lip 16 of the doctor blade device 24 and thus from premature wear.

Also in this embodiment of a screen-printing cylinder 17, an adjusting element can be provided for adjusting the doctor blade device 24 in the radial direction, for example the guide slot 26 shown in FIGS. 3a, 3b. However, since in this embodiment, the inner radius of the surface that is wiped by the doctor blade device 24 only fluctuates minimally, it is considered to be sufficient to compensate for these fluctuations solely by means of a radially flexible support (not shown) of the doctor blade device 24.

In order to prevent synchronization errors in the screen-printing cylinder 17 with such a design, when the working doctor blade 19 passes a leading edge 46 or a trailing edge 47 of the support element 36, the invention provides that these edges 46; 47 do not extend exactly parallel to a generatrix of the outer surface of the screen-printing cylinder 17 or to the lip 16 of the doctor blade device 24, but extend at a slight angle to them. For example, a sawtoothed, rafter-shaped, or sinusoidal curve of the edges 46; 47 is conceivable; preferably the edges 46; 47 each represent a helix with a pitch that is a multiple of the axial length of the screen-printing cylinder 17. When the doctor blade device 24 is running onto them or off of them, such a curvature of the edges 46; 47 prevents braking or acceleration forces acting on the screen-printing cylinder 17 from being exerted only at a certain point in time and at a particular angular position of the screen-printing cylinder 17; instead, these forces are distributed over a circumference section of the screen-printing cylinder 17 which, depending on the dimensions of the screen-printing cylinder 17, can be from several millimeters up to a few centimeters wide. This smoothes the torque required to drive the screen-printing cylinder 17 and prevents synchronization errors.

FIG. 6 shows an axial section through the vicinity printing nip 14 of an additional embodiment of the printing unit 4 according to the invention, in the same phase of its rotational movement as the one shown in FIG. 3b. Elements, which correspond to those that have already been described in relation to FIGS. 3a and 3b are provided with the same reference numerals and will not be described again here.

The difference between this embodiment and the ones in FIGS. 3a and 3b, 4, and 5 lies in the design of the doctor blade devices 24. The printing unit 4 from FIG. 6 has two differently embodied doctor blade devices 24a; 24b. Each of them has a working doctor blade 19a, 19b made of an elastically deformable material with a lip 16, which, during the course of the rotary motion of the screen-printing cylinder 17, sweeps along the inside of the screen 23 in order to press ink 34 through it. Separate from the lips 16 and parallel to them, each doctor blade device 24a; 24b has a counter-pressure device 21a; 21b in the form of a bridge that extends in the axial direction of the screen-printing cylinder 17 over the same length as the working doctor blade 19a; 19b and has an end surface 13, which sweeps along the inside of the screen 23. The counter-pressure device 21a; 21b is respectively aligned so that the end surface 13 is disposed opposite from the lip 16 of the working doctor blade 19b, 19a of the respective other doctor blade device 24b, 24a. The purpose of these counter-pressure devices 21a; 21b is to provide a buttress for the pressure exerted by the opposing working doctor blade 19b; 19a, which buttress assures that a sufficient quantity of ink passes through the screen 23 and is printed with high quality on print stock being fed through the printing nip 14. The end surface 13 of the counter-pressure devices 21a; 21b can have a width of several millimeters in the circumference direction. This assures that even when the two doctor blade devices 24a; 24b are slightly out of parallel, the pressure of each lip 16 is compensated over its entire length and as a result, a uniform printing quality is achieved over the entire width of the print stock.

In the doctor blade device 24a, the working doctor blade 19a is disposed before the counter-pressure device 21a in terms of the rotation direction of the screens 23; in the doctor blade device 24b, this is reversed. The doctor blade device 24b can therefore easily be embodied as a chamber doctor blade; the counter-pressure device 21b constitutes a closing doctor blade. The chamber defined by the working doctor blade 19b and counter-pressure device 21b can be subjected to pressure in order to control the flow rate of the ink.

Although not shown in FIG. 6, in this embodiment of the screen-printing cylinders 12; 17 as well, the indented sections 31 can be equipped with support elements 36 as shown in FIGS. 4 and 5.

Reference Numeral List

| | |
|---|---|
| 1 | sheet feeder |
| 2 | sheet stack |
| 3 | belt conveyor |
| 4 | printing unit |
| 5 | output stack |
| 6 | chain conveyor |
| 7 | transport cylinder |
| 8 | section |
| 9 | — |
| 10 | — |
| 11 | section |
| 12 | first screen-printing cylinder |
| 13 | end surface |
| 14 | printing nip |
| 15 | — |
| 16 | lip |
| 17 | second screen-printing cylinder |
| 18 | section |
| 19 | working doctor blade |
| 20 | — |
| 21 | counter-pressure device |
| 22 | support ring |
| 23 | screen |
| 24 | doctor blade device |
| 25 | — |
| 26 | guide slot |
| 27 | guide projection |
| | line |
| 28 | |
| 29 | holding mechanism, gripper bridge |
| 30 | |
| 31 | section |
| 32 | section (26) |
| 33 | section (26) |
| 34 | ink |
| 35 | — |
| 36 | support element |
| 37 | arrow |
| 38 | — |
| 39 | — |
| 40 | — |
| 41 | — |
| 42 | leading end |
| 43 | trailing end |
| 44 | — |
| 45 | — |
| 46 | leading edge |
| 47 | trailing edge |
| 19a | working doctor blade |
| 19b | working doctor blade |
| 21a | counter-pressure device |
| 21b | counter-pressure device |
| 24a | doctor blade device |
| 24b | doctor blade device |

1. A printing unit with two directly cooperating screen-printing cylinders (12; 17), characterized in that each screen-printing cylinder (12; 17) has a working doctor blade (19a; 19b) and a counter-pressure device (21a; 21b), that the counter-pressure device (21a; 21b) of the one screen-printing cylinder (12; 17) is disposed so that it supports working doctor blade (19a; 19b) of the other screen-printing cylinder (12; 17), where in terms of the rotation direction of the screen-printing cylinders (12; 17), in the one screen-printing cylinder (17), ink (34) is disposed between the working doctor blade (19b) and the counter-pressure device (21b) and in the other screen-printing cylinder (12), ink (34) is disposed after the working doctor blade (19a) and the counter-pressure device (21a).

2. The printing unit according to claim 1, characterized in that one of the two doctor blade devices (24b) is embodied as a chamber doctor blade and the counter-support device (21b) is embodied as a closing doctor blade of the chamber doctor blade.

3. The printing unit according to claim 2, characterized in that the chamber doctor blade has a device for exerting pressure on ink (34) disposed inside the chamber doctor blade.
